(19) United States
(12) Patent Application Publication
(10) Pub. No.: US 2006/0056093 A1
(43) Pub. Date: Mar. 16, 2006

(54) Method for microjog calibration by read-write zone

(76) Inventors: Richard M. Ehrlich, Saratoga, CA (US); Fernando A. Zayas, Loveland, CO (US)

Correspondence Address: FLIESLER MEYER, LLP, FOUR EMBARCADERO CENTER, SUITE 400, SAN FRANCISCO, CA, 94111, US

(21) Appl. No.: 10/939,025

(22) Filed: Sep. 10, 2004

(51) Int. Cl. G11B 21/02; G11B 5/596

(52) U.S. Cl. 360/75; 360/77.02; 360/78.04

(57) ABSTRACT

Embodiments of the present invention relate to systems, methods, and computer readable media for calibrating storage devices such as hard drives. Storage devices include storage media that are divided into differing data zones having differing data densities. A testing system initiates a series of microjog tests in the storage that are configured to determine read/write offsets indicating a distance between a write position associated with a particular location and a preferred read position for the location. To calibrate the storage device, the testing system or other product measures read/write offsets at different locations on an actuator stroke within a read/write zone. The storage device then determines predicted read/write offsets for the zone based upon the determined read/write offsets at locations in the read/write zone.

### CROSS REFERENCE TO RELATED APPLICATION

The present application relates to U.S. patent application entitled SYSTEM FOR MICROJOG CALIBRATION BY READ-WRITE ZONE by Richard M. Ehrlich and Fernando A. Zayas, (Attorney Docket No. PANAP-01147US0), filed concurrently.

### FIELD OF THE INVENTION

The present invention relates generally to calibrating storage devices. The present invention relates more specifically to determining read/write offsets associated with storage devices.

### BACKGROUND OF THE INVENTION

Over the past ten years, the mass production of storage devices has become both increasingly large in scale and increasingly competitive. The combination of aggressive computer upgrade schedules, increased storage demands driven by media applications, and the opening of foreign markets to computer sales has driven up the size and scale of storage device production. However, at the same time, increased competition has driven down the cost of computer components such as storage devices. This combination of increased scale and cost-reduction pressures has increased the importance of production efficiency.

Among the tests performed during the testing of a storage device, is a microjog test. The microjog test measures a deviation between a write position associated with a particular location and a read position associated with the location. Most microjog tests measure a read/write offset at different locations across a stroke and store this information for future reading and writing. However, current techniques are still less than optimal, often resulting in the need for rereading of data and other performance inefficiencies. What is needed is a method and system for gaining improved microjog calibration.

### BRIEF DESCRIPTION OF THE DRAWINGS

FIG. 1 is a block diagram illustrating a testing apparatus.

FIG. 2 is a block diagram illustrating a more detailed view of a hard drive.

FIG. 3 is a diagram illustrating a more detailed view of an actuator assembly.

FIG. 4 is a plan view of an exemplary rotatable storage disk that is zone bit recorded.

FIG. 5 is a block diagram illustrating a more detailed view of a read/write head.

FIG. 6 and FIG. 6B are graphs illustrating read/write offsets across differing data zones.

FIG. 7 is a flow chart illustrating a method for determining read/write offsets in accordance with one embodiment of the present invention.

### DETAILED DESCRIPTION

Embodiments of the present invention relate to systems, methods, and computer readable media for calibrating storage devices such as hard drives. A testing system is connected to a group of storage devices that are being prepared for release and eventual sale. Alternately, a storage device may be connected to an end-user system for which it is in use. The storage devices include storage media that are divided into differing data zones containing data sectors having different associated recording frequencies, so as to have nearly equal data density across a stroke. A series of microjog tests are initiated in the storage devices that are configured to determine read/write offsets indicating a distance between a write position associated with a particular location and a preferred read position for the location. To calibrate the storage device, the testing system or other product measures read/write offsets at different locations on an actuator stroke within a read/write zone. The storage device then determines predicted read/write offsets for the zone based upon the determined read/write offsets at locations in the read/write zone.

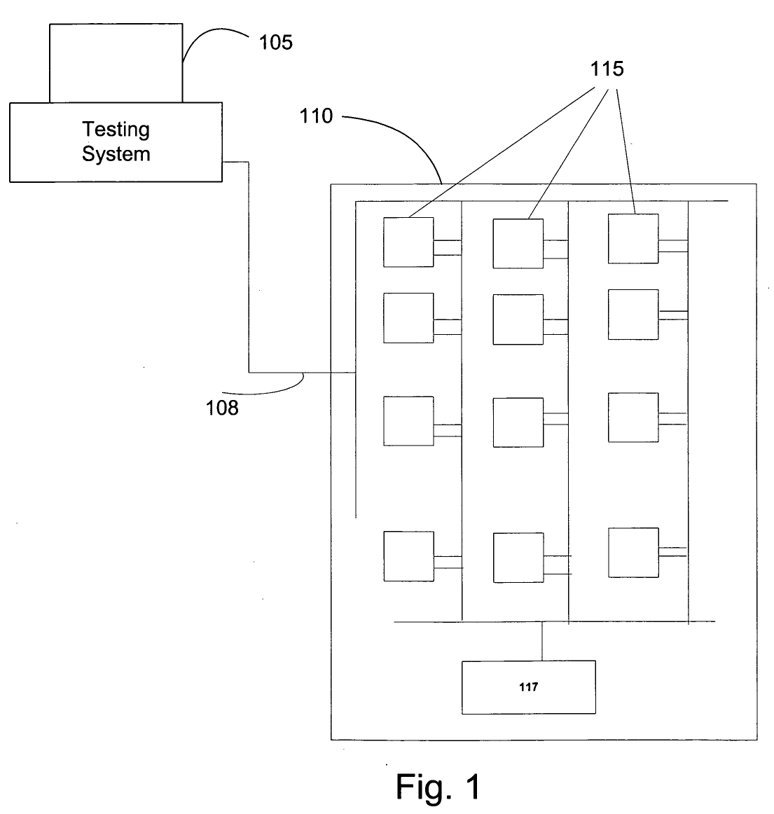

FIG. 1 is a block diagram illustrating an overview of an exemplary system for testing hard drives. The system includes a testing system 105. The testing system 105 may be a conventional computer or a computer configured specially for the purposes of storage device testing. The testing system 105 is configured to transmit testing instructions to an array 110 of hard drives 115 through an interface 108 and to receive feedback from the tested hard drives 115. The hard drives are powered through a power supply 117 connected to the array. Each hard drive has at least two connections, one for data transfer and one for power.

The hard drive array 110 includes multiple hard drives 115 that are connected to the array through one or more serial ports 108, Integrated Drive Electronics (IDE) ports, an infrared wireless connection (e.g IRDA) or some manner of proprietary connection. In the present embodiment, the hard drives 115 are new drives that have been designated for post-production assembly testing. In an alternate embodiment, the hard drives are drives that have been returned for additional diagnostics. The hard drives 115 perform a series of diagnostic tests that are received from the testing system 105 or stored internally in the hard drives 115. The test system 105 gathers output from the hard drives 115 through the serial ports 108.

In some embodiments, the testing system 105 is not connected to an array, but is a user system (e.g. computer in public or private use) which is performing diagnostics on its own internal storage device or a single external hard drive. In those embodiments, the interface 108 can be a standard host to storage interface such as an Integrated Drive electronics(IDE). The diagnostics can include tests to predict potential failures of the storage devices 115.

In additional embodiments, the hard drives are connected to the array 110 initially and instructions are downloaded from the test system 105 to the hard drives 115 through the serial ports 108. The test system 105 is then disconnected and the hard drives 115 run the tests, which in one embodiment take 20-30 hours. A system such as the test system 105 can then be reconnected to the array 110, which receives the test results from the hard drives 115. The test results are used to sort the hard drives, with the better performing drives being passed forward to the next manufacturing stage and the weaker performing drives being returned for further testing or rework.

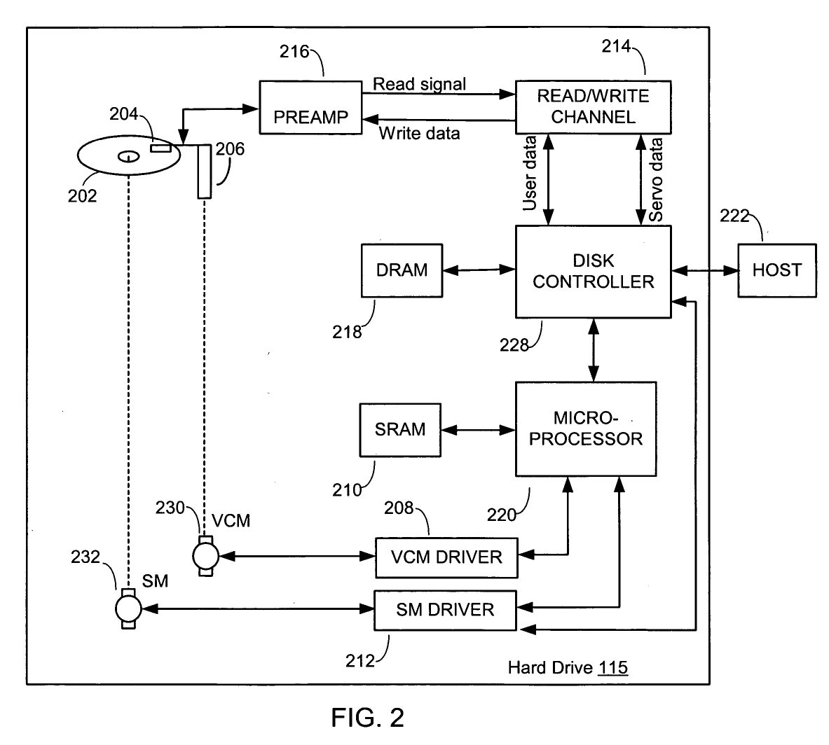

FIG. 2 shows a more detailed view of a storage device 115, which includes at least one rotatable storage medium 202 (i.e., disk) capable of storing information on at least one of its surfaces. In a magnetic disk drive as described below, the storage medium 202 is a magnetic disk. The numbers of disks and surfaces may vary from disk drive to disk drive. A closed loop servo system, including an actuator assembly 206, can be used to position a head 204 over selected tracks of the disk 202 for reading or writing, or to move the head 204 to a selected track during a seek operation. In one embodiment, the head 204 is a magnetic transducer adapted to read data from and write data to the disk 202. In another embodiment, the head 204 includes separate read and write elements. For example, the separate read element can be a magnetoresistive head, also known as an MR head. It will be understood that various head configurations may be used with embodiments of the present invention, including the characteristic that the read positions and write positions of the head differ and must be calibrated.

A servo system can include a voice coil motor driver 208 to drive a voice coil motor (VCM) 230 for rotation of the actuator assembly 206, a spindle motor driver 212 to drive a spindle motor 232 for rotation of the disk 202, a microprocessor 220 to control the VCM driver 208 and the spindle motor driver 212, and a disk controller 228 to accept information from a host 222 and to control many disk functions. The host 222 can be any device, apparatus, or system capable of utilizing the storage device 115, such as a personal computer, cellular phone, or Web server. In one embodiment, the host 222 is the test system 105. The disk controller 228 can include an interface controller in some embodiments for communicating with the host 222, and in other embodiments a separate interface controller can be used. Servo fields on the disk 202 are used for servo control to keep the head 204 on track and to assist with identifying proper locations on the disk 202 where data is written to or read from. When reading servo fields, the head 204 acts as a sensor that detects position information to provide feedback for proper positioning of the head 204 and for determination of the rotational position of the disk 202 via wedge numbers or other position identifiers.

The microprocessor 220 can also include a servo system controller, which can exist as circuitry within the drive or as an algorithm resident in the microprocessor 220, or as a combination thereof. In other embodiments, an independent servo controller can be used. Additionally, the microprocessor 220 may include some amount of memory such as SRAM, or an external memory such as SRAM 210 can be coupled with the microprocessor 220. The disk controller 228 can also provide user data to a read/write channel 214, which can send signals to a preamp 216 to be written to the disk 202, and can send servo signals to the microprocessor 220. The disk controller 228 can also include a memory controller to interface with memory 218. Memory 218 can be DRAM, which in some embodiments, can be used as a buffer memory. In alternate embodiments, it is possible for the buffer memory to be implemented in the SRAM 210.

Although shown as separate components, the VCM driver 208 and spindle motor driver 212 can be combined into a single “power controller.” It is also possible to include the spindle control circuitry in that chip. The microprocessor 220 is shown as a single unit directly communicating with the VCM driver 208, although a separate VCM controller processor (not shown) may be used in conjunction with processor 220 to control the VCM driver 208. Further, the processor 220 can directly control the spindle motor driver 212, as shown. Alternatively, a separate spindle motor controller processor (not shown) can be used in conjunction with microprocessor 220.

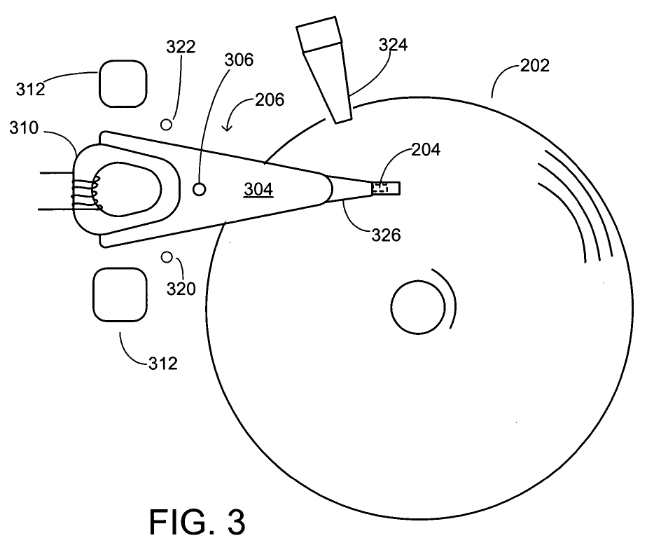

FIG. 3 shows some additional details of the actuator assembly 206. The actuator assembly 206 includes an actuator arm 304 that is positioned proximate the disk 202, and pivots about a pivot point 306 (e.g., which may be an actuator shaft). Attached to the actuator arm 304 is the read/write head 204, which can include one or more transducers for reading data from and writing data to a magnetic medium, an optical head for exchanging data with an optical medium, or another suitable read/write device. Also, attached to the actuator arm 304 is an actuator coil 310, which is also known as a voice coil or a voice actuator coil.

The voice coil 310 moves relative to one or more magnets 312 (only partially shown) when current flows through the voice coil 310. The magnets 312 and the actuator coil 310 are parts of the voice coil motor (VCM) 230, which applies a force to the actuator arm 304 to rotate it about the pivot point 306. The actuator arm 304 includes a flexible suspension member 326 (also known simply as a suspension). At the end of the suspension 326 is a mounted slider (not specifically shown) with the read/write head 204.

The VCM driver 208, under the control of the microprocessor 220 (or a dedicated VCM controller, not shown) guides the actuator arm 304 to position the read/write head 204 over a desired track, and moves the actuator arm 304 up and down a load/unload ramp 324. A latch (not shown) will typically hold the actuator arm 304 when in the parked position. The drive 115 also includes crash stops 320 and 322. Additional components, such as a disk drive housing, bearings, etc. which have not been shown for ease of illustration, can be provided by commercially available components, or components whose construction would be apparent to one of ordinary skill in the art reading this disclosure.

The actuator assembly sweeps an arc between the inner and outer diameters of the disk 202, that combined with the rotation of the disk 202 allows a read/write head 204 to access approximately an entire surface of the disk 202. The head 204 reads and/or writes data to the disks 202, and thus, can be said to be in communication with a disk 202 when reading or writing to the disk 202. Each side of each disk 202 can have an associated head 204, and the heads 204 are collectively arranged within the actuator assembly such that the heads 204 pivot in unison. In alternate embodiments, the heads can pivot independently. The spinning of the disk 202 creates air pressure beneath the slider to form a micro-gap of typically less than one micro-inch between the disk 202 and the head 204.

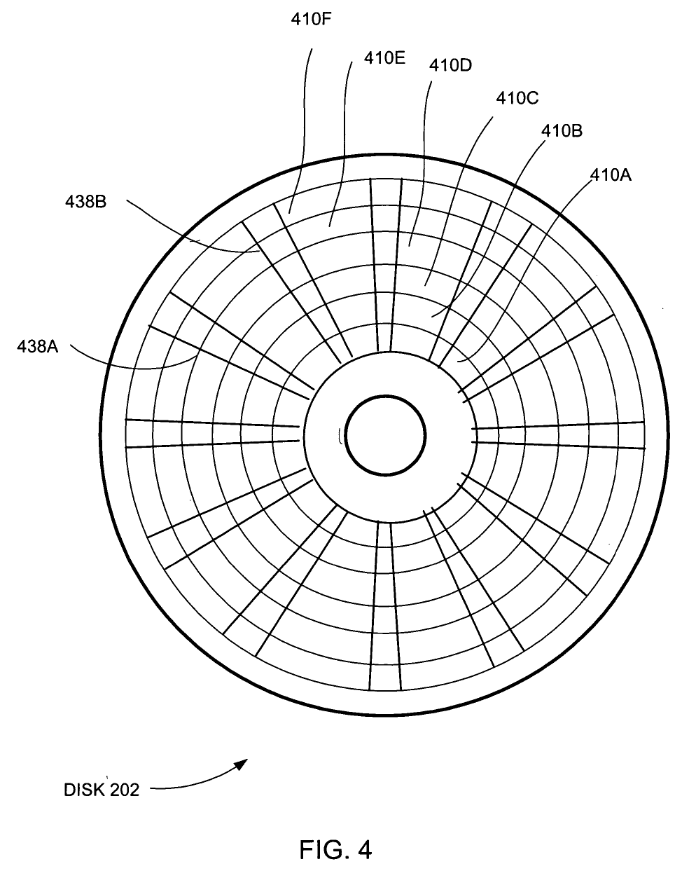

FIG. 4 is a plan view of an exemplary rotatable storage disk 202 that is zone bit recorded. The disk 202 is shown as being divided into six concentric circumferential read/write zones or regions 410A, 410B, 410C, 410D, 410E and 410F. Each track on each surface within a given zone or region contains a constant number of data sectors.

For ease of illustration, the servo wedges in FIG. 4 are simply represented by radial lines (e.g., lines 438A and 438B). In disk 202, from zone to zone, there are a constant number of servo wedges around a track, but the frequency of the data recorded between the servo wedges varies, with the outer zones typically having increasingly more data(higher frequency) between servo wedges. Thus, the while tracks in the outer regions have the same number of servo sectors(areas between servo wedges) they typically have a greater number of data sectors than the tracks in the inner zones. It is possible to split data sectors across servo sectors.

Furthermore, the number of zones, the number of servo wedges per revolution, and the number of data sectors per zone are merely exemplary. In conventional embodiments, an outermost zone will include between about 200 to 300 data sectors per track, and an innermost zone will include between about 100 to 150 data sectors per track, but of course can be more or less. Each data sector is typically 512 or 2048 bytes.

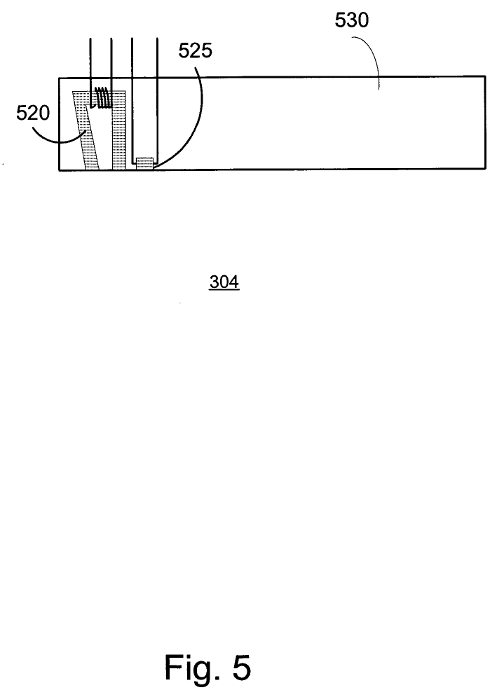

FIG. 5 is a block diagram illustrating a more detailed view of a read/write head 204. The read/write head 204 includes a write element 520 and a read element 525. The write element 520 can be, for example, an inductor coil deposited on a silicon substrate slider 530 that is used to write data on the disk 202 in the form of magnetic transitions. The read element 525 can be, for example, a magneto-resistive (MR) element that is used to detect the data transitions written on the disk 202 by the write element 520.

Although the write element 520 and read element 525 are typically deposited on the same slider in close proximity, they are still separated by a small distance on the read/write head 204. Thus, when reading a location, the hard drive must move the read/write head 204 to a slightly different position on the disk 202 as compared to when writing data from the same location. This effect increases as the read/write head moves across a stroke and the skew angle between the head and the track increases. In order to determine this read/write offset, the hard drive performs a microjog test. The microjog test involves writing data and then shifting the read/write head until a peak amplitude for the written data, or other indicator of a preferred location for reading the data, is detected by the read element 525. In some embodiments, an area is erased using direct current before the test is performed.

In one embodiment, the hard drive stores the read/write offset for future use. A predicted offset for each position on the hard drive is determined according to a series of measured read/write offsets. In some embodiments, a curve fit is applied to a series of measured offsets in order to determine a predicted read/write offset for each location on the storage medium 202. When the hard drive 115 attempts to read data from a selected location, it applies the predicted read/write offset to the write position when moving the read/write head to read the corresponding data.

In one embodiment, the hard drive performs the microjog test as part of a manufacturing and testing process and the read/write offset is set before the product is released from a testing facility. This process can entail a first testing performed at the beginning of a testing process and a second testing during a later test process.

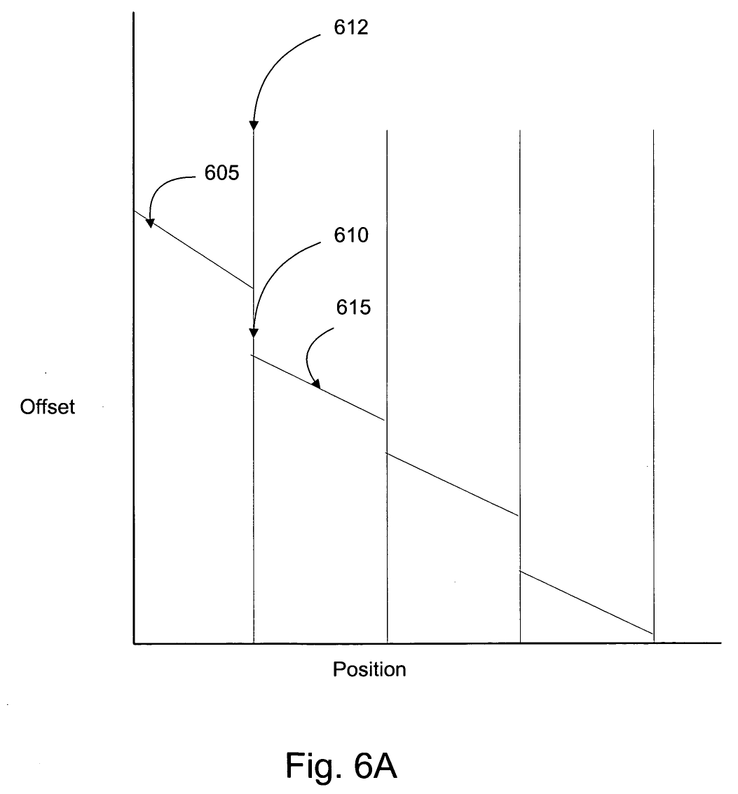

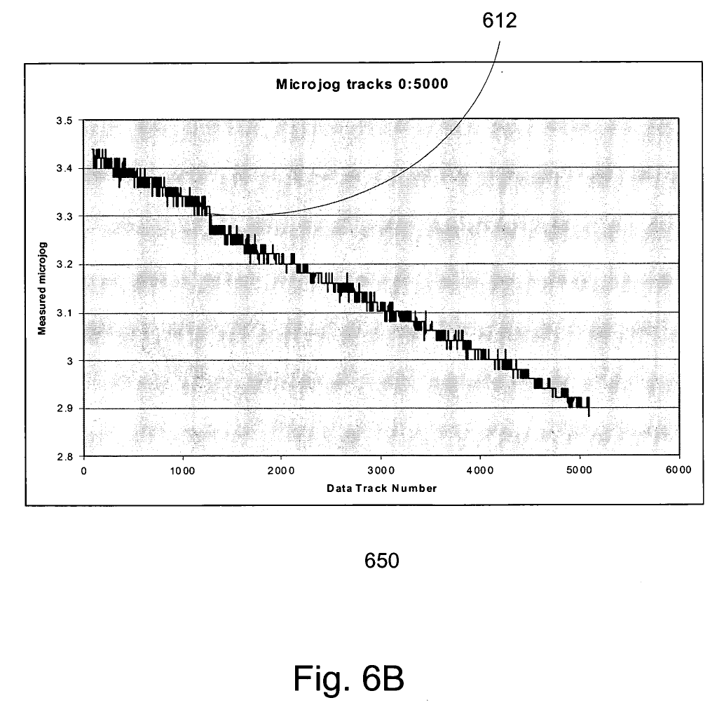

FIG. 6A and FIG. 6B are graphs illustrating offsets across differing data zone. Referring to FIG. 6A, the x-axis indicates a location within a stroke of the read/write head 204 across the disk 202. The y-axis indicates a read/write offset for that location. Vertical lines 612 correspond to borders between read/write zones. A first section 605 of the graph illustrates predicted read/write offsets in a first read/write zone 410A. The illustrated read/write offsets are predicted according to measured read/write offsets at one or more points within the zone. The second section 615 of the graph illustrates read/write offsets for a second of the read/write zones 410B. Further illustrated is a gap 610 that is associated with the border between the two data zones 410A and 410B.

The gap 610 is indicative of the fact that two points on the border between read/write zone 410A and read/write zone 410B have a larger than expected difference in their offsets, despite their proximity, due to differences in microjog performance between the two zones 410A and 410B. This gap can be attributed to differences in write current strength between zones, differences in data frequency between zones, differences in read channel settings between zones, differences in the read/write head's response to the differing data frequencies, and any number of other characteristics. Because of the observed sensitivity of the read/write offset to channel parameters, a second testing of the microjog offset after channel calibration is often used.

FIG. 6B illustrates experimental data measuring microjogs (read/write offsets) relative to distance across a stroke (measured by track number). Illustrated within the graph 650 is an offset 612 at a location corresponding to the border between read/write zones.

Typically, an expected offset is calculated by measuring read/write offsets across multiple regions and generating a predicted read/write offset for each point on the disk 202 according to the measured offsets. However, such measurements fail to take into account the differing microjog performance among the different zones 410A and 410B. Embodiments of the present invention are directed towards determining separate predicted read/write offsets for each of the zones 410 by using primarily the measured read/write offsets for points within that zone, thus achieving a higher level of accuracy. For some zones, the gap 610 isn't measurable and the zones are combined with a single fitted curve.

Other information, such as measured read/write offsets in other zones may be applied as well as long as the measured read/write offsets in the zone itself are granted disproportionate or primary weight relative to other data in determining predicted read/write offsets for the zone.

While in the present embodiment, the read/write offset is determined by measuring a peak amplitude, in an alternate embodiment it can be detected through a test that uses error rate or quality of read signal from internal measurements performed in the read channel while reading.

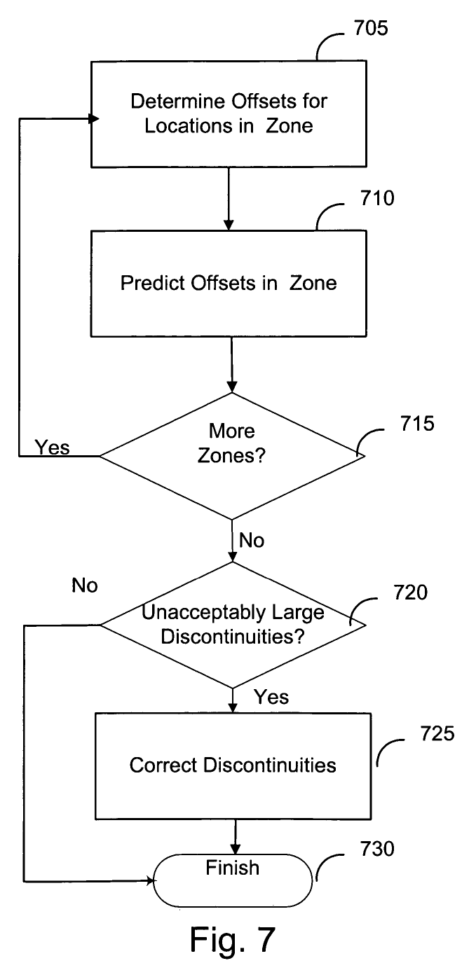

FIG. 7 is a flow chart illustrating a method for determining read/write offsets in accordance with one embodiment of the present invention. In some embodiments, this process is controlled by the microprocessor 220, the disk controller 228, or a custom control system within the hard drive 115. While in the present embodiment, this process is performed by the hard drive, in alternate embodiments it can be performed by an external system. The method begins in step 705 with the hard drive 115 determining read/write offsets at a plurality of locations within a read/write zone 410A. The read/write offsets are determined by writing data to a location on the disk 202, determining a location with a peak signal amplitude for the data when the data is read, and determining a distance between the two locations.

The hard drive 115 in step 710 generates predicted offset values for the zone 410A. This prediction step is useful as it spares the hard drive from having to determine individual read/write offsets for every location in the zone 410A. In one embodiment, the hard drive 115 generates a matching curve across the offsets determined in step 705 and determines the predicted offsets values according to the matching curve. Generating the matching curve preferably entails generating an equation that predicts the values of the read/write offsets for every location within the zone. In some embodiments, the matching curve comprises a straight line between a measured offset at the beginning of the zone and a measured offset at the end of the zone.

In step 715 hard drive checks if any additional zones remain where the hard drive has not predicted offsets. If any remain, the hard drive 115 repeats steps 705 and 710 for each of the remaining zones (e.g. 410B, 410C). When offsets have been predicted/calculated for all of the zones, the process moves to step 720. In some embodiments, for zones with similar characteristics, a single curve can be applied to multiple zones.

In step 720 the hard drive optionally checks the endpoints of adjoining zones for larger than expected discontinuities. For example, the hard drive 115 checks a predicted read/write offset at the end of zone 410A and a predicted read/write offset at the beginning of zone 410B and determines if the discontinuity is larger than a threshold amount. In setting the threshold, the hard drive may consider any number of factors, including the degree to which the adjoining zones have differing data characteristics. If there are no discontinuities above the threshold, the hard drive 115 finishes in step 730. If there are discontinuities that are larger than the threshold, in step 725 the hard drive modifies the predictive curves in those locations where the larger-than-acceptable discontinuities were detected to reduce the discontinuities to below the threshold level. The hard drive 115 then finishes the process in step 730.

Other features, aspects and objects of the invention can be obtained from a review of the figures and claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

What is claimed:

1. A method for configuring a storage device comprising a rotatable storage medium, the rotatable storage medium having a plurality of zones, the method comprising:
determining read/write offsets for a plurality of locations in each zone; and
determining predicted read/write offsets for each zone based primarily upon the determined read/write offsets for the plurality of locations in the zone.

2. The method of claim 1, wherein determining read/write offsets for a plurality of locations in each zone comprises determining a read/write offset at a beginning of the zone and a read/write offset at an end of the zone.

3. The method of claim 2, wherein determining predicted read/write offsets for each zone comprises performing an interpolation between the determined read/write offset at the beginning of the zone and the determined read/write offset at the end of the zone.

4. The method of claim 1, further comprising performing future read operations in each zone according to the predicted read/write offsets.

5. The method of claim 1, further comprising adjusting predicted read/write offsets for a first zone when a difference between a predicted read/write offset at the end of the first zone and a predicted read/write offset at a beginning of a second zone is larger than a threshold amount.

6. The method of claim 5, further comprising designating the storage device for repair in response to detecting that a preferred read location for data intended for a track would be located in an adjoining track.

7. A machine readable medium having machine readable instructions stored thereon that when executed by a processor cause a system to:
for each of a plurality of zones on a rotatable storage medium, determine read/write offsets for a plurality of locations in the zone; and
determine a predicted read/write offset for each zone based primarily upon the determined read/write offsets for the plurality of locations in the zone.

8. The machine readable medium of claim 7, further comprising instructions that when executed by the processor cause the system to determine read/write offsets for a plurality of locations in each zone by determining a read/write offset at a beginning of the zone and a read/write offset at an end of the zone.

9. The machine readable medium of claim 8, further comprising instructions that when executed by the processor cause the system to determine predicted read/write offsets for each zone by performing an interpolation between the determined read/write offset at the beginning of the zone and the determined read/write offset at the end of the zone.

10. The machine readable medium of claim 7, further comprising instructions that when executed by the processor cause the system to perform future read operations in each zone according to the predicted read/write offsets.

11. The machine readable medium of claim 7, further comprising instructions that when executed by the processor cause the system to determine from the read/write offsets whether a preferred read location for data intended for a track would be located in an adjoining track.

12. The machine readable medium of claim 11, further comprising instructions that when executed by the processor cause the system to designate the storage device for repair in response to detecting that a preferred read location for data intended for a track would be located in an adjoining track.

13. A method for configuring a storage device comprising a plurality of data zones, the method comprising:
determining a read/write offset at a beginning of each zone and at an end of each zone; and
determining predicted read/write offsets for each zone based on the determined read/write offset at the beginning of the zone and the determined read/write offset at the end of the zone.

14. The method of claim 13, further comprising performing future read operations in each zone according to the predicted offsets.

15. The method of claim 13, further comprising determining from the read/write offsets whether a preferred read location for data intended for a track would be located in an adjoining track.

16. The method of claim 15, further comprising designating the storage device for repair in response to detecting that a preferred read location for data intended for a track would be located in an adjoining track.

17. The method of claim 13, wherein determining the predicted read/write offset for each zone comprises performing an interpolation between the determined read/write offset at the beginning of the zone and the determined read/write offset at the end of the zone.

18. A machine readable medium having machine readable instructions stored thereon that when executed by a processor cause a system to:
for each zone on a rotatable storage medium comprising a plurality of zones, determine a read/write offset at a beginning of the zone and at an end of the zone; and
determine predicted read/write offsets for each zone based on the determined read/write offset at the beginning of the zone and the determined read/write offset at the end of the zone.

19. The machine readable medium of claim 18, further comprising instructions that when executed by the processor cause the system to perform future read operations in each zone according to the predicted offsets.

20. The machine readable medium of claim 18, further comprising instructions that when executed by the processor cause the system to determine from the read/write offsets whether a preferred read location for data intended for a track would be located in an adjoining track.

21. The machine readable medium of claim 20, further comprising instructions that when executed by the processor cause the system to designate the storage device for repair in response to detecting that a preferred read location for data intended for a track would be located in an adjoining track.

22. The machine readable medium of claim 18, further comprising instructions that when executed by the processor cause the system to determine the predicted read/write offset for each zone by performing an interpolation between the determined read/write offset at the beginning of the zone and the determined read/write offset at the end of the zone.

23. A method for configuring a storage device comprising a rotatable storage medium, the rotatable storage medium having a plurality of zones, each zone having a different data density, the method comprising:
determining read/write offsets for a plurality of locations in each zone; and
generating a predictive curve for each zone, wherein:
each curve corresponds to one zone;
each curve is generated according to determined read/write offsets within its corresponding zone; and
values of a first axis of each curve represent locations on the rotatable storage medium within its corresponding zone and values of a second axis of each curve represent read/write offsets for the locations on the rotatable storage medium within its corresponding zone.
